(19) United States
(12) Patent Application Publication
(10) Pub. No.: US 2008/0225156 A1
(43) Pub. Date: Sep. 18, 2008

(54) Digital image processing apparatus with rotating display device

(75) Inventor: Young-oog Kim, Seongnam-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/891,988

(22) Filed: Aug. 14, 2007

(30) Foreign Application Priority Data
Mar. 14, 2007 (KR) 10-2007-0025079

(51) Int. Cl. H04N 5/225

(52) U.S. Cl. 348/333.06

(57) ABSTRACT

Provided is a digital image processing apparatus including a body and a rotating display device rotatably installed on the body. The rotating display device comprises: a display panel that displays an image; and a direction sensor for sensing a direction of the display panel. Various embodiments of the direction sensor are also disclosed including, for example, a direction sensor that is capable of sensing at least four rotational states of the rotating display device. In addition, the image displayed on the display panel may be reversed if the direction sensor detects that the rotating display device has been rotated.

### CROSS-REFERENCE TO RELATED PATENT APPLICATION

This application claims the benefit of Korean Patent Application No. 10-2007-0025079, filed on Mar. 14, 2007, in the Korean Intellectual Property Office, the disclosure of which is incorporated herein in its entirety by reference.

### BACKGROUND OF THE INVENTION

1. Field of the Invention

The present invention relates generally to a digital image processing apparatus. More particularly, the present invention relates to a digital image processing apparatus having a display device that is capable of rotating to enable a user to easily take photographs at various angles.

2. Description of the Related Art

Conventionally, there are many different types of digital image processing apparatuses, including, for example, digital cameras, personal digital assistants (PDAs), phone cameras, personal computer (PC) cameras, etc. Such digital image processing apparatuses receive a desired image through an imaging device, display the image on an image display device, and store the image as an image file according to a photographing selection of a user.

A digital image processing apparatus such as a digital camera may include a rotating display device to enable a user to take a photograph or self-photograph at various angles.

Korean Patent Publication Gazette No. 2004-0095022 discloses a portable photographing apparatus having a rotating display device that is connected to a body of the portable photographing apparatus through a hinge unit. The portable photographing apparatus uses the hinge unit to sense whether the rotating display device has rotated. The hinge unit uses a cam and a switch to sense the rotation of the rotating display device. If the rotating display device rotates, the cam of the hinge unit also rotates, and the switch of the hinge unit operates due to the rotation of the cam. When the switch is operated, the portable photographing apparatus reverses an image displayed on the rotating display device. Thus, the portable photographing apparatus correctly displays the image to a user even if the rotating display device rotates. Therefore, the portable photographing apparatus having the rotating display device allows a user to take photographs or self-photographs at various angles.

However, a rotating display device that senses rotation using the cam and switch method described above may be difficult to assemble. In particular, it may be difficult to attach or otherwise configure the switch on the rotating display device due to a narrow space of the rotating display device. Also, if an assembling deviation occurs, a recognition error may also occur during rotation of the display device such that the image is displayed incorrectly.

Also, the cost of the portable photographing apparatus having the rotating display device is high and a flexible printed circuit board (FPCB) in the portable photographing apparatus may short-circuit due to the complexity of the FPCB.

### SUMMARY OF THE INVENTION

The present invention provides a digital image processing apparatus including a rotating display device having a direction sensor. The direction sensor allows the digital image processing apparatus to easily sense a rotation of the rotating display device.

According to an aspect of the present invention, a digital image processing apparatus comprises a body and a rotating display device rotatably installed on the body. The rotating display device comprises a display panel that displays an image and a direction sensor for sensing a direction of the display panel.

The rotating display device may further comprise a case enclosing the display panel so that a first surface of the display panel is exposed and a printed circuit board (PCB) is mounted on a second surface of the display panel. In an embodiment, the direction sensor is positioned inside the case on a first surface of the PCB. The first surface of the PCB is opposite to a second surface of the PCB, which faces the second surface of the display panel.

The rotating display device may further comprise: first and second contact points formed by extending conductive patterns on the first surface of the PCB in one direction; a direction-indicating bar moving along a direction of the display panel in the direction along which the first and second contact points extend from a first position to a second position in order to electrically connect or couple the first and second contact points; and a cover enclosing the direction-indicating bar and the first and second contact points with the PCB.

The digital image processing apparatus may further comprise a controller for determining whether an image displayed on the display panel should be rotated or reversed. The controller may make this determination according to a current detected by a current detector. In an embodiment, the PCB of the rotating display device includes a resistor, the current detector, and a power supply unit connected between the first and second contact points.

The body of the digital image processing apparatus may comprise a case, a PCB mounted inside the case, and a direction sensor positioned on a surface of the PCB. The direction sensor, which senses an orientation of the body, comprises at least one contact point disposed on the PCB; a cover enclosing the at least one contact point with the PCB; and a direction-indicating unit. In an embodiment, the cover is conductive, and the direction-indicating unit electrically connects the at least one contact point to the cover, depending on an orientation of the body. If the at least one contact point comprises more than one contact point, the direction-indicating unit may electrically connect fewer than all of the at least one contact points to the cover. Alternatively, the cover is not conductive and the at least one contact point comprises more than one contact point so that the direction-indicating unit may electrically connect at least two of the at least one contact points.

In an embodiment, the direction sensor of the rotating display device comprises: a conductive contact point disposed on the first surface of the PCB, which is opposite to a second surface of the PCB facing the display panel; a conductive cover enclosing the conductive contact point with the PCB; and a direction-indicating ball moving along a direction of the display panel to electrically connect the conductive contact point to the cover or to electrically disconnect the conductive contact point from the cover.

According to another aspect of the present invention, the rotating display device of the digital image processing apparatus comprises: a display panel that displays an image; a case enclosing the display panel so that a first surface of the display panel is exposed; a PCB mounted on a second surface of the display panel; and a direction sensor that senses a direction of the display panel, wherein the direction sensor senses at least four direction rotation states of the rotating display device.

The direction sensor may comprise: at least four conductive contact points disposed on a first surface of the PCB; a conductive cover enclosing the at least four conductive contact points with the PCB; and a direction-indicating ball moving along a direction of the display panel to electrically connect one of the four conductive contact points to the cover.

In another embodiment, the direction sensor may include: at least four conductive contact points disposed on a first surface of the PCB; a non-conductive cover enclosing the at least four conductive contact points with the PCB; and a direction-indicating ball that moves along a direction of the display panel to electrically connect two of the four conductive contact points.

Thus, according to the present invention, a rotating display device can include a direction sensor to easily sense a rotation of the rotating display device.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a back view of a digital camera, as an example of a digital image processing apparatus, having a rotating display device, according to an embodiment of the present invention;

FIG. 2 illustrates the rotating display device of the digital camera of FIG. 1, in an unfolded and rotated position, according to an embodiment of the present invention;

FIG. 3 is a cross-sectional view of a direction sensor installed in the rotating display device of the digital camera of FIG. 1, according to an embodiment of the present invention;

FIG. 4 is a schematic cross-sectional view of a direction sensor installed in a body of the digital camera of FIG. 1, according to an embodiment of the present invention;

FIG. 5 schematically illustrates a direction sensor with two contact points that are electrically connected to each other through a direction-indicating bar to sense a direction of the rotating display device, according to an embodiment of the present invention;

FIG. 6 is a cross-sectional view illustrating the two contact points that are electrically connected to each other through the direction-indicating bar in the direction sensor of FIG. 5 when the rotating display device faces a direction, according to an embodiment of the present invention;

FIG. 7 is a cross-sectional view illustrating the two contact points that are not electrically connected to each other through the direction-indicating bar in the direction sensor of FIG. 5 when the rotating display device faces another direction, according to an embodiment of the present invention;

FIG. 8 schematically illustrates a principle for recognizing a direction of the rotating display device in the direction sensor of FIG. 5, according to an embodiment of the present invention;

FIG. 9 schematically illustrates a direction sensor electrically connecting a contact point to a cover through a direction-indicating ball to sense a direction of the rotating display device, according to another embodiment of the present invention;

FIG. 10 is a cross-sectional view illustrating the cover that is electrically connected to the contact point through the direction-indicating ball in the direction sensor of FIG. 9 when the rotating display device faces one direction, according to an embodiment of the present invention;

FIG. 11 is a cross-sectional view illustrating the cover which is not electrically connected to the contact point in the direction sensor of FIG. 9 when the rotating display device faces another direction, according to an embodiment of the present invention;

FIG. 12 illustrates a direction sensor having two direction-indicating balls, according to an embodiment of the present invention;

FIG. 13 schematically illustrates a direction sensor that senses rotation states of a rotating display device in terms of up, down, left, and right directions, according to another embodiment of the present invention;

FIG. 14 is a cross-sectional view of the direction sensor of FIG. 13, according to an embodiment of the present invention;

FIG. 15 schematically illustrates a principle for recognizing a direction of the rotating display device in the direction sensor of FIG. 13, according to an embodiment of the present invention;

FIG. 16 schematically illustrates a direction sensor electrically connecting two of a plurality of contact points through a direction-indicating ball to sense four direction rotation states of the rotating display device, according to another embodiment of the present invention;

FIG. 17 is a cross-sectional view of the direction sensor of FIG. 16, according to another embodiment of the present invention;

FIG. 18 schematically illustrates a principle for recognizing a direction of the rotating display device in the direction sensor of FIG. 16, according to an embodiment of the present invention;

FIG. 19 schematically illustrates an image stored in a digital camera when a display panel of a rotating display device is placed on a body so as to expose a back surface thereof as a reference orientation, wherein the digital camera includes a body and the rotating display device respectively having direction sensors, according to an embodiment of the present invention;

FIGS. 20 through 23 schematically illustrate images stored depending on rotation states of the body and the rotating display device with respect to a reference orientation of the rotating display device of FIG. 19; and

FIG. 24 is a block diagram of a digital image processing apparatus according to an embodiment of the present invention.

### DETAILED DESCRIPTION OF THE INVENTION

Embodiments of the present invention will now be described in detail with reference to the attached drawings.

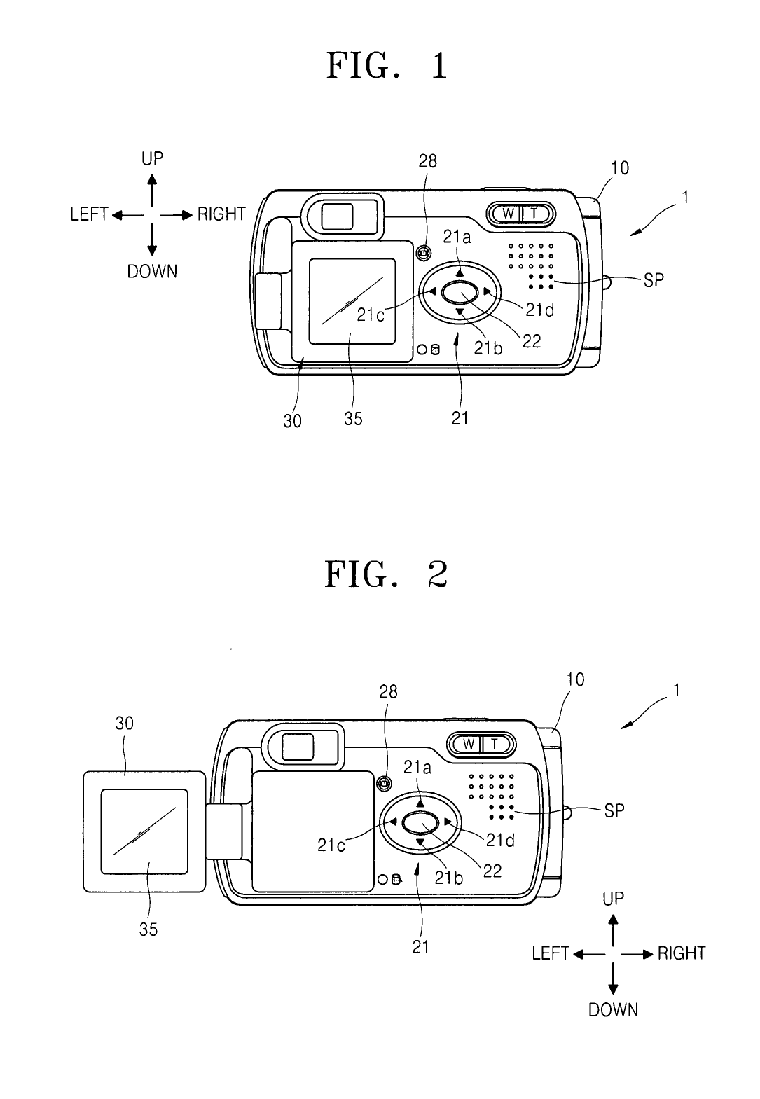

FIG. 1 illustrates a back view of a digital camera 1, which is an example of a digital image processing apparatus, having a rotating display device 30, according to an embodiment of the present invention. FIG. 2 illustrates the rotating display device 30 of the digital camera 1 of FIG. 1, which is in an unfolded and rotated position.

Referring to FIGS. 1 and 2, the digital image processing apparatus includes a direction button 21 a Menu-OK button 22, a Wide-angle Zoom button W, a Telephoto Zoom button T, a rotating display device 30, a display button 28, and a speaker SP.

The direction button 21 may comprise four buttons, i.e., an up button 21a, a down button 21b, a left button 21c, and a right button 21d. Various menus related to operations of the digital camera 1 can be accessed and executed through the direction button 21 and the Menu-OK button 22.

The Wide-angle Zoom button W or the Telephoto Zoom button T may allow a camera angle to be wide or narrow according to its input. In particular, the Wide-angle Zoom button W and the Telephoto Zoom button T may be used to change a size of a selected area. Hence, if the Wide-angle Zoom button W is pressed, the selected area may be zoomed out. If the Telephoto Zoom button T is pressed, the selected area may be zoomed in.

The digital camera 1, which is an example of a digital image processing apparatus having a rotating display device, includes a body 10 and the rotating display device 30. The rotating display device 30 may include a display panel 35 including an image display such as a liquid crystal display (LCD). The rotating display device 30 is rotatably installed on the body 10. As shown in FIG. 1, the display panel 35 of the rotating display device 30 is placed on the body 10 so that the display panel 35 is exposed.

In this embodiment, an image is displayed in a reference orientation in which the display panel 35 is exposed as shown in FIG. 1. For convenience, in the discussion of this embodiment, an upward direction in which an image is displayed is assigned as the reference orientation.

FIG. 2 illustrates the rotating display device 30 of the digital camera 1 of FIG. 1 which has been unfolded and rotated by 180°. When the rotating display device 30 is arranged as shown in FIG. 2, an image displayed on the rotating display device 30 is reversed by 180° to be normally shown to a user.

The display button 28 can be manipulated to check current photographing settings and information through the display panel 35. Also, the display button 28 can be manipulated to reverse an image by 180° and then display the reversed image on the display panel 35. If a menu screen is not clear due to a bright background, the bright background may be darkened through the manipulation of the display button 28 to make the menu screen clear and only display a pure image without photographing information.

A shutter release button, a flash, a power switch, and a lens unit may be provided on a front or upper surface of the digital camera 1. An objective lens and an ocular lens of a viewfinder may be further provided on the front or back surface of the digital camera 1.

The shutter release button is pressed to expose an imaging device such as a charge-coupled device or a film to light for a predetermined period of time. The shutter release button is also linked to a diaphragm (not shown) to appropriately expose an object so as to record an image on the image device.

The flash momentarily illuminates a dark place that is being photographed. Examples of a flash mode include an auto flash, compulsory light emission, light emission prohibition, a red eye reduction, a slow synchro, etc. The objective lens of the viewfinder is a small window of a camera through which an object to be photographed is viewed to set a composition.

An example of a digital image processing apparatus to which the present invention can be applied is disclosed in U.S. Patent Publication No. 2004/0130650, entitled “Method of Automatically Focusing Using a Quadratic Function in Camera.” The conventional details of the present apparatus are discussed hereinafter with reference to FIG. 24. However, a method for controlling conventional aspects (e.g., photographing, image storage, etc.) of the present apparatus are relatively well-know in the art and, therefore, their detailed descriptions will be omitted herein.

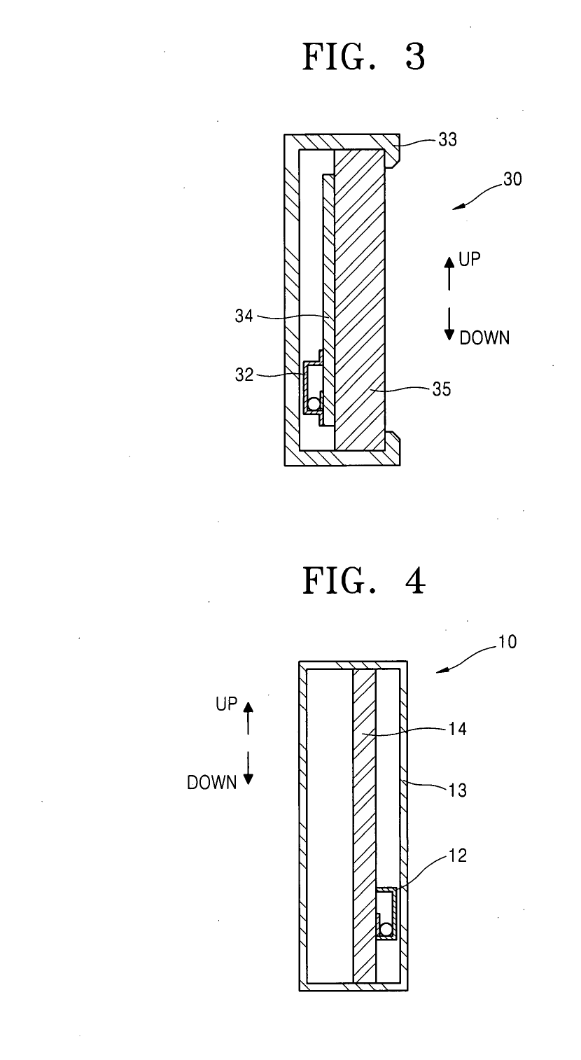

FIG. 3 is a cross-sectional view of a direction sensor 32 installed in the rotating display device 30 of the digital camera 1 of FIG. 1, according to an embodiment of the present invention. FIG. 4 is a schematic cross-sectional view of a body direction sensor 12 installed in the body 10 of the digital camera 1 of FIG. 1, according to an embodiment of the present invention.

Referring to FIG. 3, the rotating display device 30 includes the direction sensor 32, a display case 33, a printed circuit board (PCB) 34, and the display panel 35 that displays an image. The direction sensor 32 senses an orientation of the rotating display device 30 including the display panel 35. In other words, the direction sensor 32 senses which direction the rotating display device 30 faces.

The display case 33 encloses the display panel 35 so as to expose a first surface of the display panel 35 on which the image is displayed. The PCB 34 is mounted on a second surface of the display panel 35, which is opposite to the first surface on which the image is displayed on the display panel 35. The PCB 34 and the direction sensor 32 are positioned inside the display case 33. As shown in FIG. 3, the direction sensor 32 may be positioned on a first surface of the PCB 34, which is opposite to a second surface of the PCB 34 facing the display panel 35.

Referring to FIG. 4, the body 10 comprises a second PCB 14 inside a body case 13. A body direction sensor 12 is positioned on a first surface of the second PCB 14 inside the second case 13. The body direction sensor 12 senses an orientation of the body 10. In other words, the body direction sensor 12 senses which direction the body 10 faces. For convenience of explanation, in the discussion of this embodiment, a direction in which an image is displayed is referred to as a reference orientation.

The body direction sensor 12 or the direction sensor 32 according to the present invention may be installed, respectively, in the body 10 or the rotating display 30. For example, the direction sensor 32 may be installed in the rotating display device 30 to sense an orientation of the rotating display device 30. If an orientation of the body 10 is fixed and an orientation of the rotating display device 30 is changed, a direction of an image displayed on the display panel 35 may be changed, i.e., rotated.

The body direction sensor 12 or the direction sensor 32 may be installed, respectively, in the body 10 or the rotating device 30 to respectively sense an orientation of the body 10 or the rotating display device 30. In this case, a direction of an image displayed on the display panel 35 may be changed and the image may be displayed depending on a relative orientation of the body 10 or the rotating display device 30.

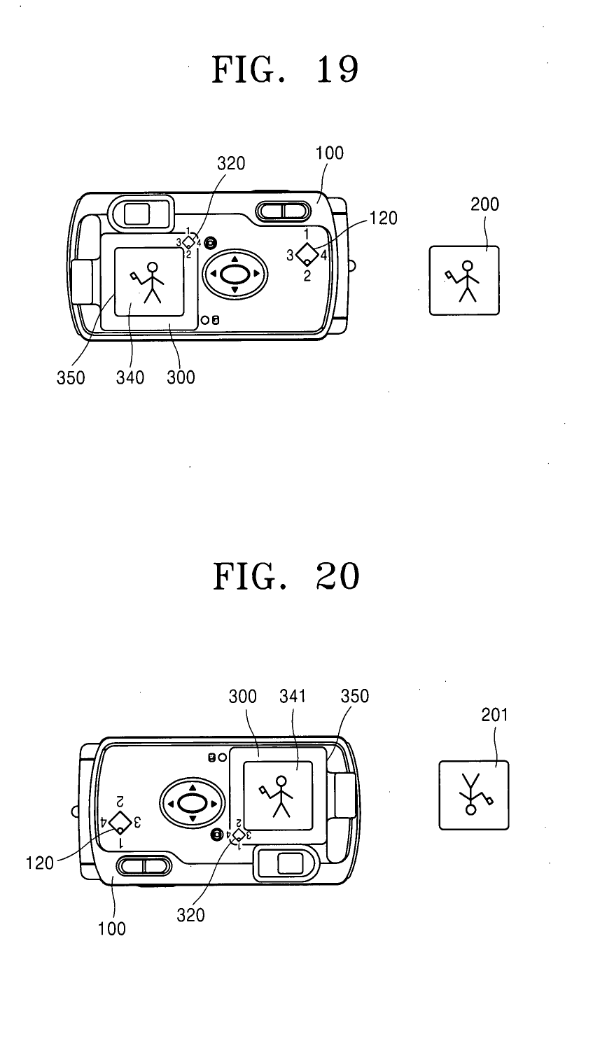

When photographing is performed while the body 10 is rotated as shown in FIGS. 19 through 23, an image may be stored depending on the rotation state of the body 10. In this case, even if the photographing is performed while the body 10 is rotated, a user can reproduce a photographed image without reversing the photographed image, even in the reference orientation of the body 10.

According to an embodiment of the present invention, the orientations of the body 10 and the rotating display device 30 can be sensed. In addition, a rotation of a rotating display device can be easily sensed. In particular, additional complicated devices such as a cam and a switch are not required to sense an orientation of the rotating display device 30 with respect to the body 10, i.e., a rotation state of the rotating display device 30.

Various embodiments of a direction sensor will now be described. The direction sensor is generally installed in the rotating display device 30; however, the direction sensor also may be installed in the body 10.

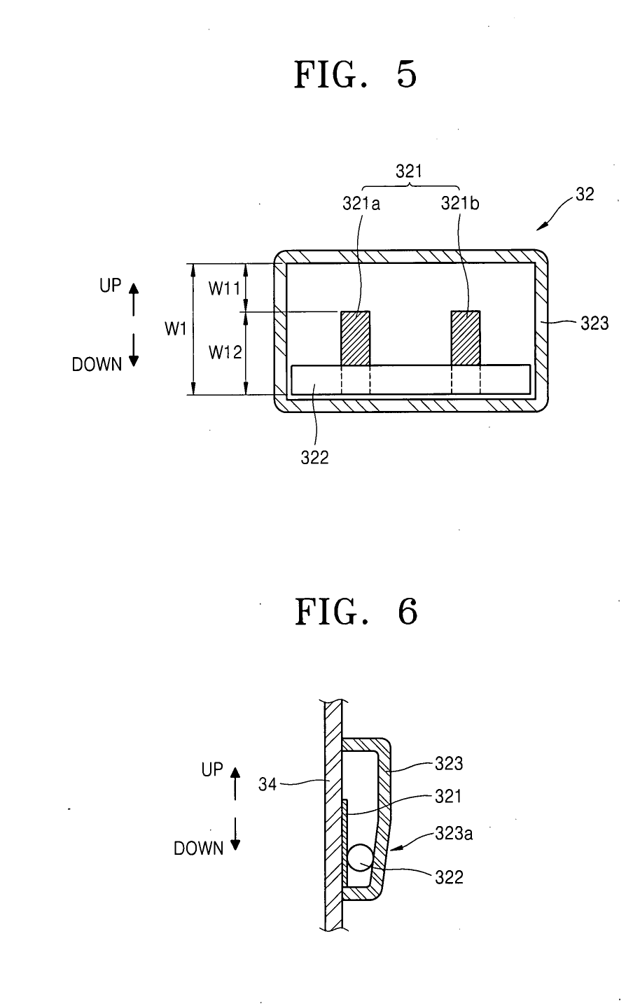

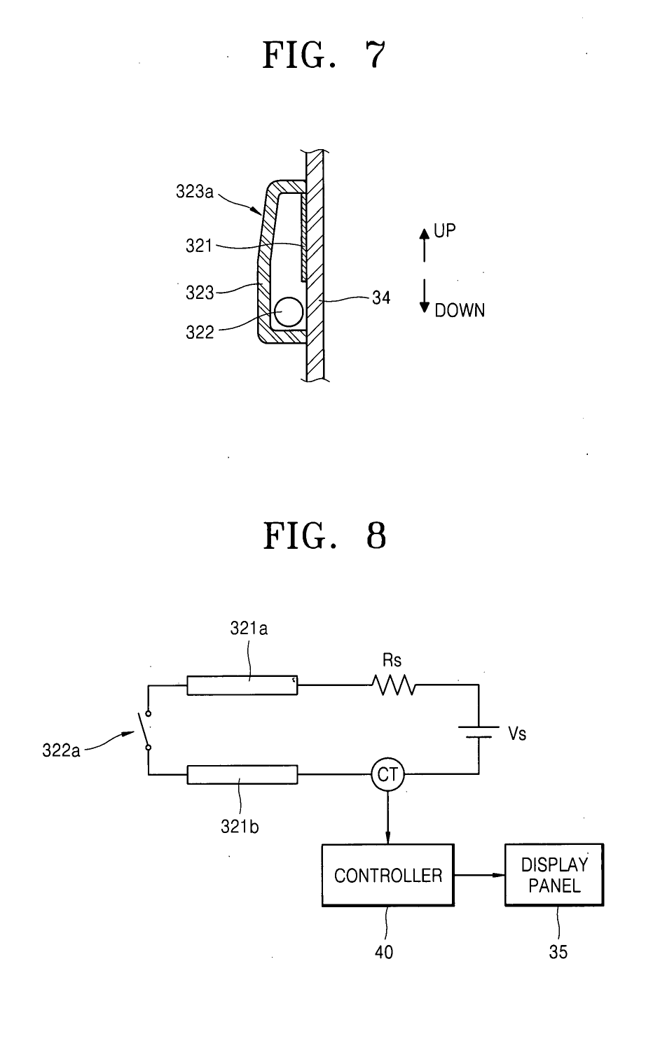

A first embodiment of the direction sensor will now be discussed with reference to FIGS. 5-8. Referring to FIG. 5, the direction sensor 32 electrically connects first and second contact points 321a and 321b to each other through a direction-indicating bar 322 to sense a direction of the rotating display device 30. Referring to FIG. 6, if an upper portion of the rotating display device 30 faces upward, the first and second contact points 321a and 321b of the direction sensor 32 of FIG. 5 are electrically connected to each other through the direction-indicating bar 322. Referring to FIG. 7, if a lower portion of the rotating display device 30 faces upward, the first and second contact points 321a and 321b of the direction sensor 32 of FIG. 5 are not electrically connected to each other through the direction-indicating bar 322.

In this embodiment, the direction sensor 32 comprises a contact point 321 including the first and second contact points 321a and 321b, the direction-indicating bar 322, and a cover 323. A conductive pattern extends on the first surface of the PCB 34, which is opposite to the second surface of the PCB 34 facing the display panel 35, to form the contact point 321. The direction-indicating bar 322 moves in a direction along which the first and second contact points 321a and 321b extend in order to electrically connect the first and second contact points 321a and 321b or electrically disconnect the first and second contact points 321a and 321b. The cover 323 is connected to the PCB 34 and encloses the direction-indicating bar 322, the first contact point 321a and the second contact point 321b.

The direction-indicating bar 322 may be configured as a generally cylindrical member having a circular, elliptical or annular-shaped cross-section. In other words, the direction-indicating bar 322 may have a shape so as to be able to move inside the cover 323 in the direction along which the first and second contact points 321a and 321b extend. In this embodiment, the direction-indicating bar 322 may be formed of a conductive material so as to electrically connect the first and second contact points 321a and 321b.

The contact point 321 extends on the PCB 34 in up and down directions so as to sense whether the rotating display device 30 is in an upward or downward orientation. In this embodiment, the contact point 321 may extend a distance longer than half of a first width W1 in a direction along which the first and second contact points 321a and 321b extend inside the cover 323. The contact point 321, however, should extend less than a difference between the first width W1 and a longest width of a section of the direction-indicating bar 322.

When the upper portion of the rotating display device 30 faces upward, the direction-indicating bar 322 moves downward due to gravity so as to electrically connect the first and second contact points 321a and 321b. Thus, an upward orientation of the upper portion of the rotating display 30 can be sensed. Also, if the lower portion of the rotating display device 30 faces upward, the direction-indicating bar 322 moves to a portion of the PCB in which the first and second contact points 321a and 321b do not exist. Thus, an upper orientation of the lower portion of the rotating display device 30 also can be sensed.

As shown in FIG. 6, a distance between the PCB 34 and a portion 323a of the cover 323 facing the first and second contact points 321a and 321b may be shortened toward an end of the cover 323. In other words, toward an end of the cover 323 where the contact point 321 is positioned, the cover 323 may be inclined to narrow a space between the portion 323a of the cover 323 and the contact point 321. Thus, the portion 323a is configured to positively urge the direction-indicating bar 322 into electrical connection with the first and second contact points 321a and 321b.

If the upper portion of the rotating display device 30 faces upward, as shown in FIG. 6, the first and second contact points 321a and 321b are positioned in the lower portion of the rotating display device 30. Thus, the first and second contact points 321a and 321b are connected to each other through the direction-indicating bar 322. However, the present invention is not limited to this arrangement. For example, the first and second contact points 321a and 321b may be located in the upper portion of the rotating display device 30 such that if the lower portion of the rotating display device 30 faces upward, the first and second contact points 321a and 321b are electrically connected via the direction-indicating bar 322.

FIG. 8 schematically illustrates a principle for recognizing an orientation of the rotating display device 30 through the direction sensor 32 of FIG. 5, according to an embodiment of the present invention. Referring to FIG. 8, the digital camera 1 including the rotating display device 30 may include a power supply unit Vs, a resistor Rs, a current detector CT, and a controller 40. The power supply unit Vs, the resistor Rs, and the current detector CT are connected in series between the first and second contact points 321a and 321b. Hence, the direction-indicating bar 322 operates as a switch 322a of FIG. 8.

The controller 40 determines whether an image displayed on the display panel 35 has been reversed according to a current detected by the current detector CT.

If the upper portion of the rotating display device 30 faces upward as described with reference to FIG. 6, the direction-indicating bar 322 moves downward to electrically connect the first and second contact points 321a and 321b. Hence, the current is detected by the current detector CT, and a current signal is input to the controller 40. If the controller 40 receives the current signal from the current detector CT, the controller 40 determines that the rotating display device 30 has rotated from a reference orientation relative to the body 10, and the controller 40 reverses the image displayed on the display panel 35.

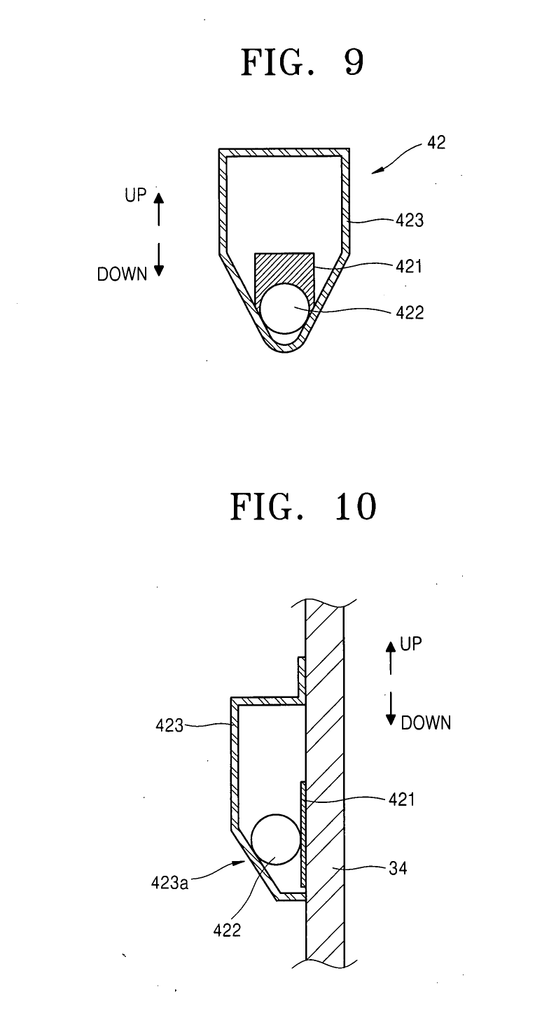

A direction sensor according to another embodiment of the present invention will now be described with reference to FIGS. 9-11.

FIG. 9 schematically illustrates a direction sensor 42. The direction sensor 42 of FIG. 9 electrically connects a contact point 421 to a cover 423 through a direction-indicating ball 422 to sense a direction of the rotating display device 30. In an embodiment, the contact point 421 is formed of a conductive material on the PCB 34, and the cover 423 and direction-indicating ball 422 are also formed of a conductive material.

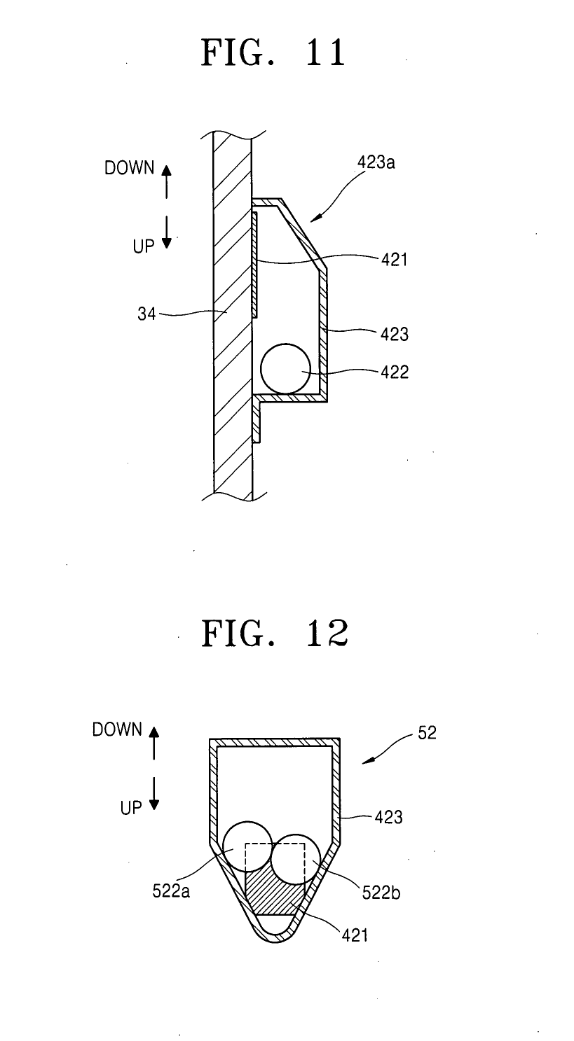

FIG. 10 is a cross-sectional view of the direction sensor 42 of FIG. 9 when the upper portion of the rotating display device 30 faces upward. As shown in FIG. 10, when the upper portion of the rotating display device 30 faces upward, the contact point 421 is electrically connected to the cover 423 through the direction-indicating ball 422. FIG. 11 is a cross-sectional view of the direction sensor 42 of FIG. 9 when the lower portion of the rotating display device 30 faces upward. As shown in FIG. 11, when the lower portion of the rotating display device 30 faces upward, the contact point 421 is not electrically connected to the cover 423.

Referring to FIG. 9, an embodiment of the direction sensor 42 comprises the contact point 421, the direction-indicating ball 422, and the cover 423. A conductive pattern is formed on a first surface of the PCB 34, which is opposite to a second surface of the PCB 34 facing the display panel 35, to form the contact point 421.

The direction-indicating ball 422 moves along a direction of the display panel 35 to electrically connect the contact point 421 and the cover 423 or electrically disconnect the contact point 421 and the cover 423. The direction-indicating ball 422 may have a spherical shape so as to freely move through a pathway formed inside the second cover 423. The cover 423 is connected to the PCB 34 and encloses the contact point 421. The PCB 34 may be formed of a conductive material.

The cover 423 may be formed to provide the pathway in a space between the cover 423 and the PCB 34, wherein the direction-indicating ball 422 moves up or down through the pathway in the space between the cover 423 and the PCB 34. Also, the contact point 421 may be formed at a lower end inside the cover 423. Here, if the upper portion of the rotating display device 30 faces upward, the direction-indicating ball 422 may move down to be disposed in the lower end inside the cover 423, so that the contact point 421 electrically connects with the cover 423 through the direction-indicating ball 422.

In an embodiment, the cover 423 may have a shape in which a width of a space inside the cover 423 is narrowed (i.e., portion 432a) toward the contact point 421 so that the portion 432a urges direction-indicating ball 422 into positive connection with contact point 421.

Also, a distance of a portion of the cover 423 facing the contact point 421 from the PCB 34 may be shortened toward the lower end of the cover 423. In other words, the cover 423 may have inclined sidewall portions that direct the ball 422 toward the contact point 421. In this way, the contact point 421 electrically connects with the cover 423 through the direction-indicating ball 422.

If the upper portion of the rotating display device 30 faces upward, the direction-indicating ball 422 moves down and thus electrically connects the cover 423 and the contact point 421. In an embodiment, the direction-indicating ball 422 electrically connects the cover 423 and the contact point 421 due to a narrow space in the cover 423. Thus, an orientation of the upper portion of the rotating display device 30 facing upward can be sensed.

If the lower portion of the rotating display 30 faces upward, the direction-indicating ball 422 moves down to a portion of the cover 423 in which the contact point 421 is not configured. Thus, the direction-indicating ball 422 does not electrically connect the cover 423 and the contact point 421 when the lower portion of the rotating display device 30 is facing upward. Accordingly, an orientation of the lower portion of the rotating display device 30 facing upward can be sensed.

In the embodiment shown in FIGS. 9-11, if the upper portion of the rotating display device 30 faces upward, the contact point 421 is positioned in a lower portion of the cover 423 so that the contact point 421 is electrically connected to the cover 423 through the direction-indicating ball 422. However, the present invention is not limited to this. For example, the contact point 421 may be positioned such that the contact point 421 is in the upper portion of the cover 423. In such a configuration, the direction-indicating ball 422 does not electrically connect the cover 423 and the contact point 421 when the lower portion of the rotating display device 30 is facing upward.

Another embodiment of a direction sensor according to the present invention will now be discussed with reference to FIG. 12. Referring to FIG. 12, a direction sensor 52 comprises the contact point 421, the cover 423, and at least two direction-indicating balls 522a and 522b which contact each other between the contact point 421 and the cover 423.

As with the direction sensor 32, the direction sensors 42 and 52 can sense directions according to the principle described with reference to FIG. 8. In the direction sensor 32, the direction-indicating ball 422 operates as the switch 322 of FIG. 8 to electrically connect the cover 423 and the contact point 421. The cover 423 and the contact point 421 are represented in the diagram of FIG. 8 by the first and second contact points 321a and 321b. Similarly, in the direction sensor 52, the at least two direction-indicating balls 522a and 522b operate as the switch 322 of FIG. 8 to electrically connect the cover 423 and the contact point 421.

In other words, with respect to the direction sensor 42, if the upper portion of the rotating display device 30 faces upward, the direction-indicating ball 422 moves down to electrically connect the contact point 421 and the cover 423. Hence, a current is detected by the current detector CT, and a current signal is input to the controller 40. If the controller 40 receives the current signal from the current detector CT, the controller 40 determines that the rotating display device 30 has rotated from a basic orientation relative to the body 10, and the controller 40 reverses an image displayed on the display panel 35.

Similarly, with respect to the direction sensor 52, if the upper portion of the rotating display device 30 faces upward, the at least two direction-indicating balls 522a and 522b move down to electrically connect the contact point 421 and the cover 423. Hence, a current is detected by the current detector CT, and a current signal is input to the controller 40. If the controller 40 receives the current signal from the current detector CT, the controller 40 determines that the rotating display device 30 has rotated from a basic orientation relative to the body 10, and the controller 40 reverses an image displayed on the display panel 35.

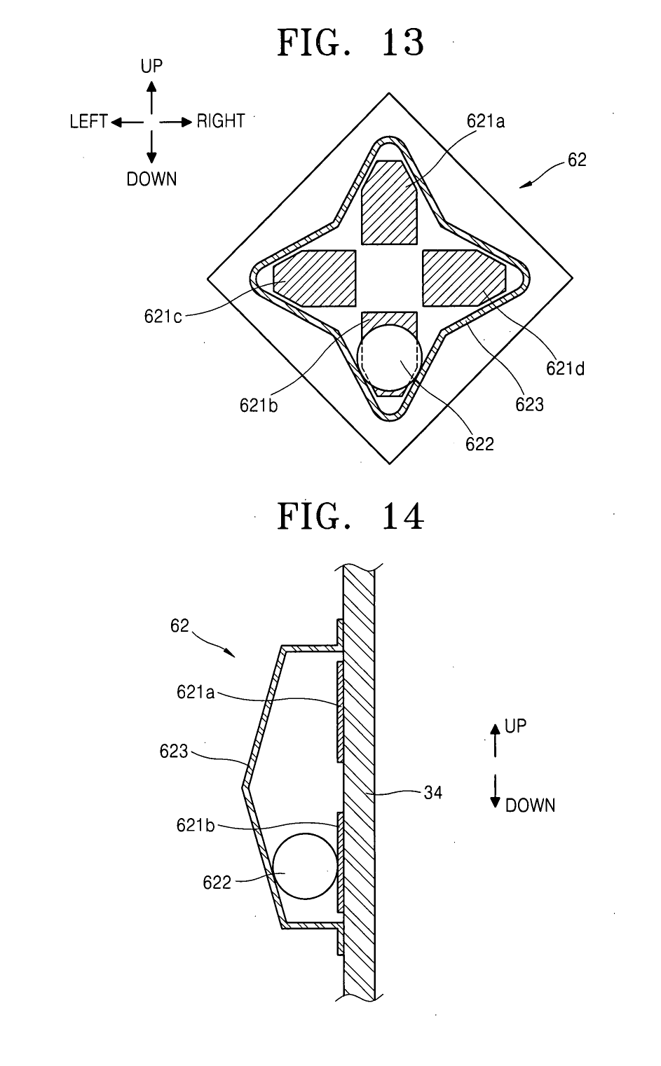

Another embodiment of the present invention will now be discussed with reference to FIGS. 13-15. FIG. 13 illustrates a direction sensor 62 that senses rotation states of the rotating display device 30 in four directions, e.g., up, down, left, and right directions. FIG. 14 is a cross-sectional view of the direction sensor 62 of FIG. 13.

Referring to FIGS. 13 and 14, the direction sensor 62 comprises four contact points 621a, 621b, 621c, and 621d, a direction-indicating ball 622, and a cover 623. The four contact points 621a, 621b, 621c, and 621d are disposed on the first surface of a PCB 34, which is opposite to the second surface of the PCB 34 that is on the display panel 35, and are formed of a conductive material.

The cover 623, which is connected to the PCB 34, encloses the contact points 621a, 621b, 621c, and 621d and is formed of a conductive material. The direction-indicating ball 622 moves according to the orientation of the rotating display device 30, and a rotation state of the rotating display device 30, to electrically connect the cover 623 to one of the four contact points 621a, 621b, 621c, and 621d.

The direction sensor 62, as shown in FIG. 13, recognizes the rotation state of the rotating display device 30 using the same principle as the direction sensor 42 of FIG. 9. However, the direction sensor 62 of FIG. 13 includes four contact points 621a, 621b, 621c, and 621d and thus can sense four directions.

The cover 623 may be formed to provide a pathway in a space between the cover 623 and the PCB 34 so that the direction-indicating ball 622 moves through the pathway in up, down, left, and right directions. Also, the four contact points 621a, 621b, 621c, and 621d may respectively be formed at upper, lower, left, and right ends inside the cover 623.

If the upper portion of the rotating display device 30 faces upward, the direction-indicating ball 622 moves down so that the contact point 621b electrically connects with the cover 623 through the direction-indicating ball 622. If the lower portion of the rotating display device 30 faces upward, the direction-indicating ball 622 moves down so that the contact point 621a electrically connects with the cover 623 through the direction-indicating ball 622.

If a left portion of the rotating display device 30 faces upward, the direction-indicating ball 622 moves down so that the contact point 621d electrically connects with the cover 623 through the direction-indicating ball 622. If a right portion of the rotating display device 30 faces upward, the direction-indicting ball 622 moves down so that the contact point 621c electrically connects with the cover 623 through the direction-indicating ball 622.

The cover 623 may have a shape so that a width of a space of the cover 623 in which the direction-indicating ball 622 moves is narrowed toward portions of the cover 623 near where the four contact points 621a, 621b, 621c, and 621d are respectively positioned. Thus, the four contact points 621a, 621b, 621c, and 621d may easily contact the cover 623 through the direction-indicating ball 622.

In addition, a distance between the portions of the cover 623 facing the four contact points 621a, 621b, 621c, and 621d and the PCB 34 may be shortened toward ends of the cover 623. In other words, the cover 623 may incline to narrow spaces of the portions of the cover 623 in which the four contact points 621a, 621b, 621c, and 621d are positioned toward the ends of the cover 623, so that the cover 623 may be electrically connected to the four contact points 621a, 621b, 621c, and 621d through the direction-indicating ball 622.

If the upper portion of the rotating display device 30 faces upward, the direction-indicating ball 622 moves down and thus electrically connects the cover 623 and the contact point 621b due to a narrow space of the cover 623. Thus, the cover 623 and the contact point 621b are electrically connected to each other through the direction-indicating ball 622. Thus, an orientation of the upper portion of the rotating display device 30 facing upward can be sensed, and the rotation states of the rotating display device 30 can be sensed.

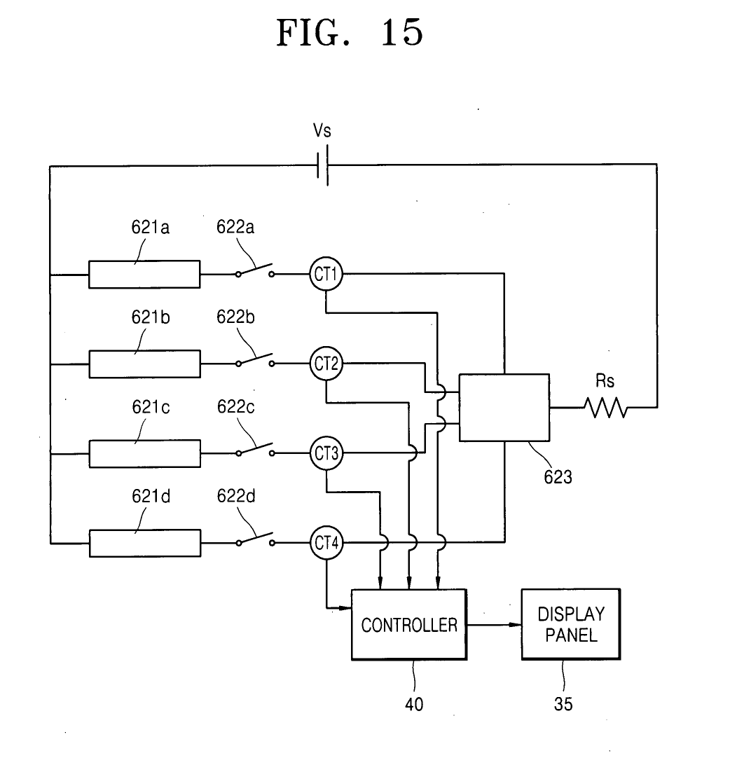

FIG. 15 illustrates the principle for recognizing a direction of the rotating display device 30 through the direction sensor 62 of FIG. 13, according to an embodiment of the present invention. Referring to FIG. 15, a power supply unit Vs, resistor Rs, current detectors CT1, CT2, CT3, and CT4, and the controller 40 are disposed on the PCB 34 of the digital camera 1 having the rotating display device 30. The power supply unit Vs, the resistor Rs, and the current detector CT1 are connected in series with contact points 621a and the cover 623. Similarly, each of current detectors CT2, CT3, and CT4 is connected in series with, respectively, contact points 621b, 621c, and 621d, in addition to the power supply unit Vs and the resistor Rs. The direction-indicating ball 622 of FIG. 13 operates as switches 622a, 622b, 622c, and 622d of FIG. 15.

The controller 40 determines whether an image displayed on the display panel 35 has been rotated in up, down, left, and right directions according to the current detected by the current detectors CT1, CT2, CT3, and CT4.

If the upper portion of the rotating display device 30 faces upward as shown in FIG. 14, the direction-indicating ball 622 moves downward to electrically connect the contact point 621b to the cover 623. Hence, a current is detected by the current detector CT2, and a current signal is input to the controller 40.

If the lower portion of the rotating display device 30 faces upward, the direction-indicating ball 622 moves downward to electrically connect the contact point 621a to the cover 623. Hence, a current is detected by the current detector CT1, and a current signal is input to the controller 40.

If a left portion of the rotating display device 30 faces upward, the direction-indicating ball 622 moves downward to electrically connect the contact point 621d to the cover 623. Hence, a current is detected by the current detector CT4, and a current signal is input to the controller 40.

If a right portion of the rotating display device 30 faces upward, the direction-indicating ball 622 moves downward to electrically connect the contact point 621c to the cover 623. Hence, a current is detected by the current detector CT3, and a current signal is input to the controller 40.

Thus, if the controller 40 receives the current signals from the current detectors CT1, CT2, CT3, and CT4, the controller 40 determines whether the rotating display device 30 has rotated from the reference orientation relative to the body 10, and, if the rotating display device 30 has rotated, the controller 40 rotates the image displayed on the display panel 35. In particular, the controller 40 rotates the image displayed on the display panel 35 at 90° angles until the image is displayed correctly.

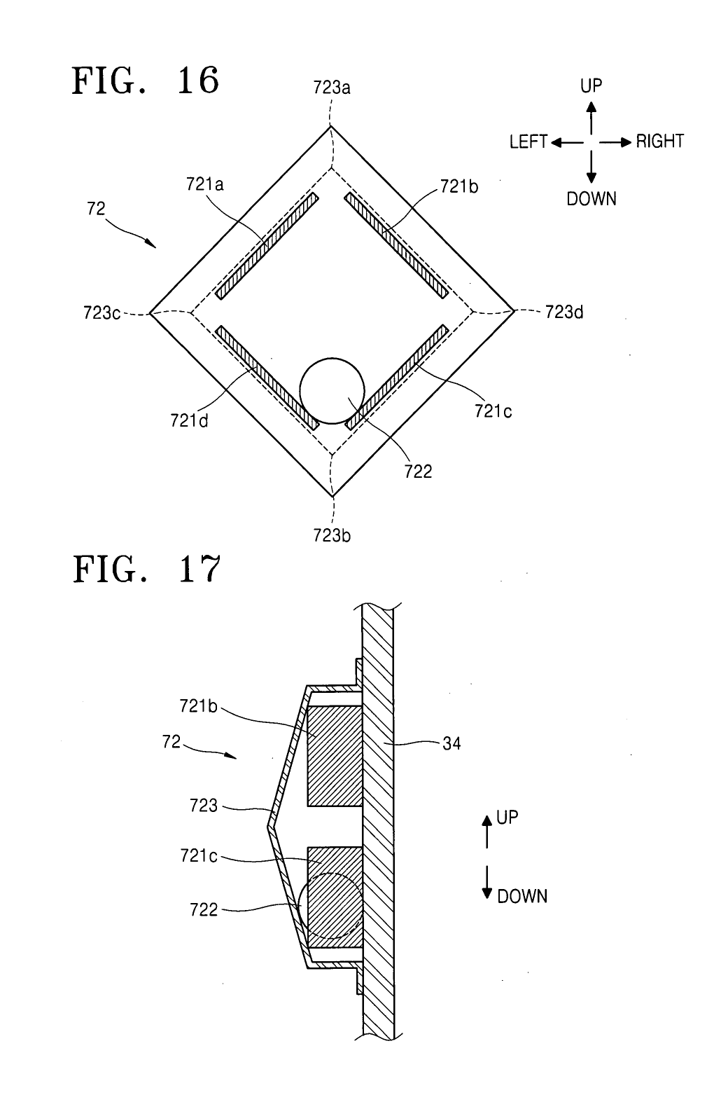

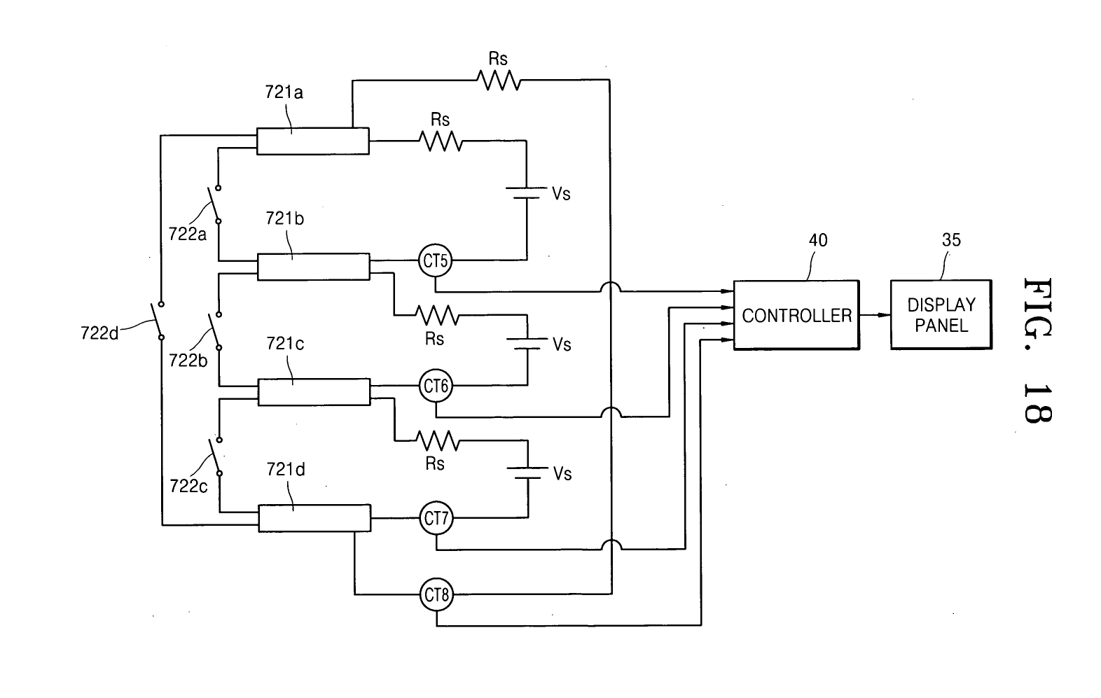

Another embodiment of the present invention will now be described with reference to FIGS. 16-18. FIG. 16 illustrates a direction sensor 72 capable of electrically connecting two of a plurality of contact points 721a, 721b, 721c, and 721d through a direction-indicating ball 72 to sense four direction rotation states of the rotating display device 30. FIG. 17 is a cross-sectional view of the direction sensor 72 of FIG. 16, according to an embodiment of the present invention.

Referring to FIGS. 16 and 17, the direction sensor 72 comprises the contact points 721a, 721b, 721c, and 721d, the direction-indicating ball 722, and a cover 723. The contact points 721a, 721b, 721c, and 721d are disposed on a first surface of the PCB 34, which is opposite to a second surface of the PCB 34 facing the display panel 35 inside the cover 723, and are formed of a conductive material.

The cover 723 encloses the contact points 721a, 721b, 721c, and 721d with the PCB 34, and is formed of a nonconductive material. The direction-indicating ball 722 moves depending on an orientation of the rotating display device 30, i.e., a rotation state, to electrically connect two of the contact points 721a, 721b, 721c, and 721d.

The cover 723 includes corners 723a, 723b, 723c, and 723d to indicate four directions through movements of the direction-indicating ball 722. If the rotating display device 30 faces one direction, the direction-indicating ball 722 moves to one of the corners 723a, 723b, 723c, and 723d to electrically connect two of the contact points 721a, 721b, 721c, and 721d.

The contact points 721a, 721b, 721c, and 721d may extend along sides of the cover 723 to protrude from the PCB 34 toward the cover 723 so as to have larger widths than a radius of the cover 723. Hence, a distance of the cover 723 from the PCB 34 may be shortened toward a portion in which two contact points are close to each other, i.e., the corners 723a, 723b, 723c, and 723d.

If the rotating display device 30 faces one direction, the direction-indicating ball 722 moves to one of the corners 723a, 723b, 723c, and 723d to electrically connect two of the contact points 721a, 721b, 721c, and 721d. Thus, a rotation state of the rotating display device 30 may be sensed.

FIG. 18 illustrates the principle for recognizing a direction of the rotating display device 30 using the direction sensor 72 of FIG. 16, according to an embodiment of the present invention. Referring to FIG. 18, power supply units Vs, resistors Rs, current detectors CT5, CT6, CT7, and CT8, and the controller 40 are disposed on the PCB 34 of the digital camera 1 with the rotating display device 30. The power supply units Vs, the resistors Rs, and the current detectors CT5, CT6, CT7, and CT8 are connected in series between two of the contact points 721a, 721b, 721c, and 721d. In particular, the current detector CT5 is connected in series with power supply unit Vs, resistor Rs, and contact points 721a and 721b. The current detector CT6 is connected in series with power supply unit Vs, resistor Rs, and contact points 721b and 721c. The current detector CT7 is connected in series with power supply unit Vs, resistor Rs, and contact points 721c and 721d. The current detector CT8 is connected in series with power supply unit Vs, resistor Rs, and contact points 721d and 721a. The direction-indicating ball 722 of FIG. 16 operates as switches 722a, 722b, 722c, and 722d of FIG. 18.

The controller 40 determines whether an image displayed on the display panel 35 has rotated in up, down, left, and right directions according to a current detected by one of current detectors CT5, CT6, CT7, and CT8.

If the upper portion of the rotating display device 30 faces upward in the embodiment described with reference to FIG. 16, the direction-indicating ball 72 moves to the corner 723b to electrically connect the contact points 721c and 721d. Hence, a current is detected by the current detector CT7, and a current signal is input to the controller 40.

If the lower portion of the rotating display device 30 faces upward, the direction-indicating ball 722 moves to the corner 723a to electrically connect the contact points 721a and 721b. Hence, a current is detected by the current detector CT5, and a current signal is input to the controller 40.

If the left portion of the rotating display device 30 faces upward, the direction-indicating ball 722 moves to the corner 723d to electrically connect the contact points 721b and 721c. Hence, a current is detected by the current detector CT6, and a current signal is input to the controller 40.

If the right portion of the rotating display device 30 faces upward, the direction-indicating ball 72 moves to the corner 723c to electrically connect the contact points 721d and 721a. Hence, a current is detected by the current detector CT8, and a current signal is input to the controller 40.

If the controller 40 receives the current signals from the current detectors CT5, CT6, CT7, and CT8, the controller 40 determines whether the rotating display device 30 has rotated from a reference orientation relative to the body 10, and if the rotating display device 30 has rotated, the controller 40 reverses an image displayed on the display panel 35.

The display and storage of images according to an embodiment of the present invention will now be discussed with reference to FIGS. 19-23. FIG. 19 illustrates a digital camera comprising a body 100 and a rotating display device 300 respectively having direction sensors 120 and 320, according to an embodiment of the present invention. If a display panel 350 of the rotating display device 300 is placed on the body 100 so that a back surface thereof is shown, an image 340 displayed on the display panel 350 and a stored image 200 are shown. In this case, the image 340 displayed on the display panel 350 is an image input through an imaging device. Also, the image 200 is stored on a recording medium without being rotated.

FIGS. 19 through 23 illustrate direction sensors 120 and 320 respectively installed on the body 100 and the rotating display device 300 to sense four directions.

Referring to FIGS. 20 through 23, images 341, 342, 343, and 344 displayed on the display panel 350 and stored images 201, 202, 203, and 204 depend on rotation states of the body 100 and the rotating display device 300 from the reference orientation of the rotating display device 300 of FIG. 19.

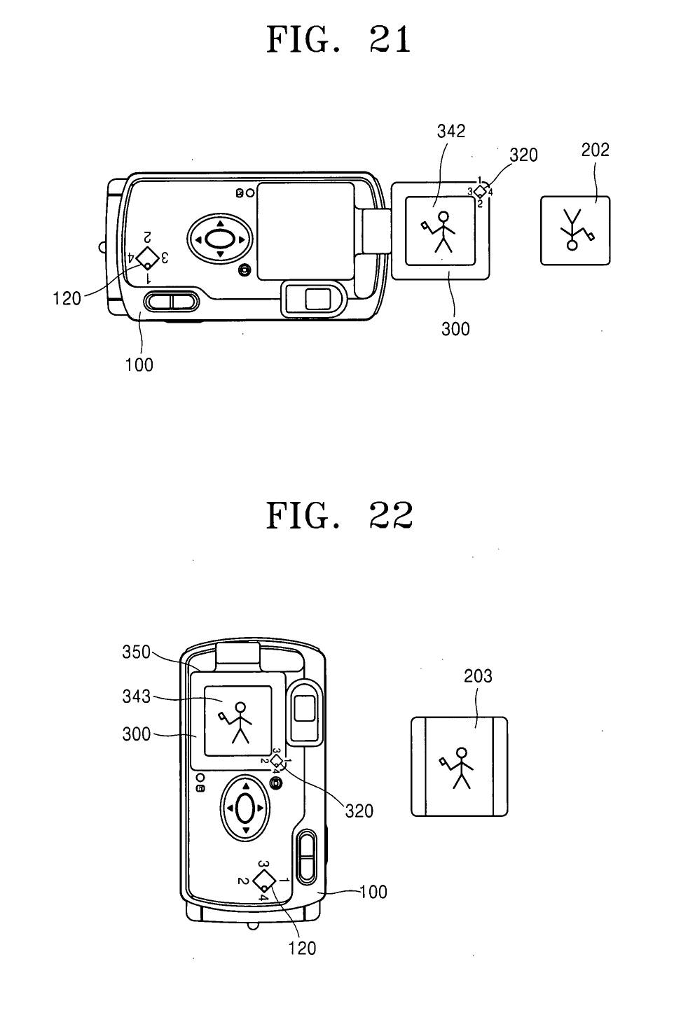

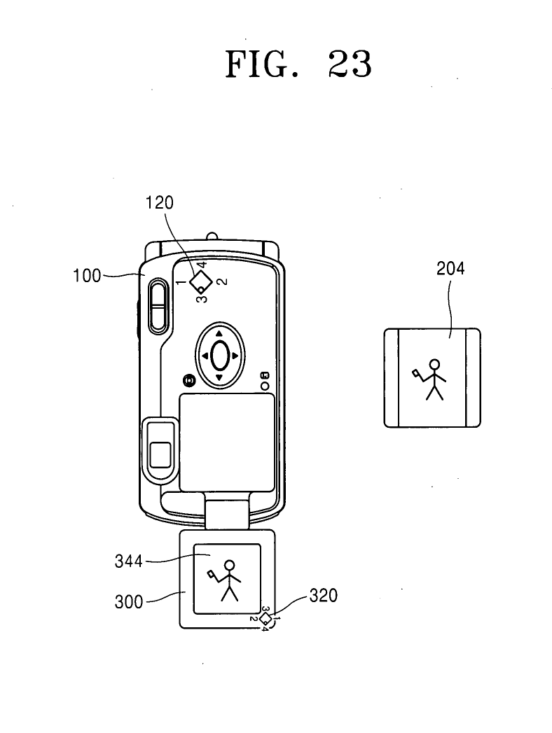

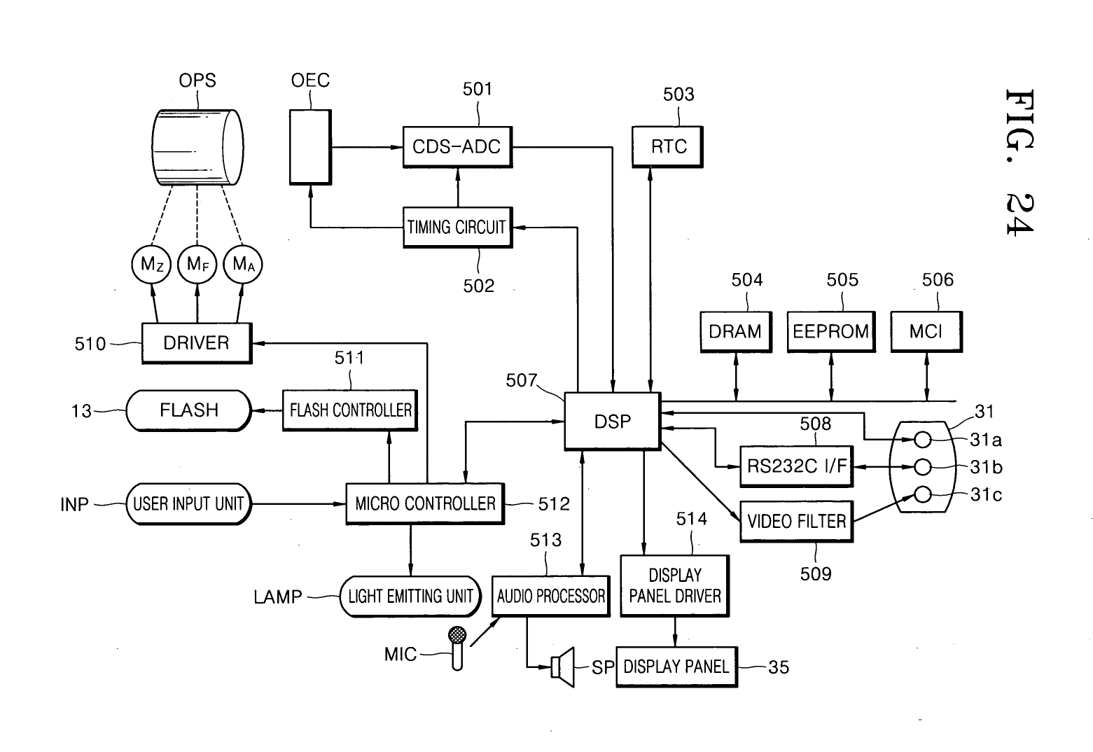

If a relative orientation of the rotating display device 30 changes relative to the body 100, an image displayed on the display panel 350 is rotated and displayed. Thus, in the cases of FIGS. 21 and 23, where the rotating display device 30 has been unfolded from the body 100 and has been rotated by 180°, the images 342 and 344 displayed on the display panel 350 are rotated by 180° and displayed.

If the body 100 rotates from the reference orientation, an image is compensated for by the amount of the rotation of the body 100 and then stored on the recording medium. For example, as shown in FIGS. 20 and 21, if photographing occurs when the body 100 is rotated by 180°, the images 201 and 202 are rotated by 180° and stored.

FIG. 22 illustrates what happens when the body 100 is rotated clockwise by 90° when a photograph is taken. As shown in FIG. 22, the image 203 is rotated clockwise by 90° and then stored on the recording medium. Similarly, as shown in FIG. 23, if the body 100 is rotated counterclockwise by 90° when a photograph is taken, the image 204 is also rotated counterclockwise by 90° and then stored on the recording medium.

According to an embodiment of the present invention, if photographing occurs in a rotation state of the body 100, the rotation state of the body 100 may be taken into account when storing an image. Thus, even if photographing occurs in a rotation state of the body 100, the stored image may be reproduced even in a reference orientation of the body 100 without being reversed by a user. This is possible when a rotation degree of the body 100 can be sensed with respect to the reference orientation.

Also, in an embodiment, if photographing is performed in a state where the body 100 is rotated, a function of storing an image depending on the rotation state of the body 100 may be turned on and/or off by the user through a menu. In this case, if the user takes a photograph in the rotation state of the body 100, the user may select whether the rotation state of the body 100 is to be considered when the image is stored.

FIG. 24 is a block diagram of a digital image processing apparatus according to an embodiment of the present invention. Referring to FIG. 24, an optical system (OPS) including a lens unit and a filter unit. The filter unit optically processes light incident from an object. The lens unit of the OPS includes a zoom lens, a focus lens, and a compensation lens.

If a user presses the Wide-angle Zoom button W or the Telephoto Zoom button T of the user input unit INP, a signal corresponding to this is input to a micro controller 512. The micro controller 512 controls a lens driver 510 to drive a zoom motor M_{Z} to move the zoom lens. In other words, if the Wide-angle Zoom button W is pressed, a focal distance of the zoom lens is shortened, and thus a view angle is widened. If the Telephoto Zoom button T is pressed, the focal distance of the zoom lens is lengthened, and thus the view angle is narrowed.

In an auto focus mode, a main controller of a digital signal processor (DSP) 507 controls the lens driver 510 through the micro controller 512 to drive a focus motor M_{F}. The compensation lens compensates for a whole refractive index and thus is not additionally driven. Additionally, a motor M_{A} is used for driving a diaphragm (not shown).

An optical low pass filter (LPF) of the filter unit of the OPS removes optical noise from a high frequency component. An infrared cut filter (IRF) intercepts an infrared component of incident light.

A photoelectric converter (OEC) may include an imaging device such as a charge-coupled device (CCD) or a complementary metal-oxide-semiconductor (CMOS) in order to convert light incident from the OPS into an electrical analog signal.

An analog-to-digital converter (ADC) may include a correlation double sampler and analog-to-digital converter (CDS-ADC) 501. The CDS-ADC 501 processes the electrical analog signal output from the OEC to remove high frequency noise from the electrical analog signal, adjust amplitude of the electrical analog signal, and convert the electrical analog signal into a digital signal. Hence, the DSP 507 controls a timing circuit 502 to control operations of the OEC and the CDS-ADC 501.

A real-time clock (RTC) 503 provides real-time information to the DSP 507. The DSP 507 processes the digital signal output from the CDS-ADC 501 to generate a digital image signal, which is divided into luminescent and chromatic signals.

A light emitting unit LAMP is driven by the micro controller 512 under the control of the main controller of the DSP 507, and may include a self-timer lamp, an auto-focus lamp, a mode indicating lamp, a flash standby lamp, etc. As shown in the digital camera of FIG. 1, the user input unit INP may include a shutter release button, a direction button 21, the Wide-angle Zoom button W, the Telephoto Zoom button T, etc.

A dynamic random access memory (DRAM) 504 temporarily stores the digital image signal output from the DSP 507. An electrically erasable and programmable read only memory (EEPROM) 505 stores algorithms such as a booting program necessary for an operation of the DSP 507, a key input program, etc., and setup data. A memory card of the user is attached to and/or detached from a memory card interface (MCI) 506.

The digital image signal output from the DSP 507 is input to a display panel driver 514, and thus an image is displayed on the display panel 35.

The digital image signal output from the DSP 507 may be transmitted as a serial communication through a universal serial bus (USB) connector 31a or a RS232C interface 508 and a connector 31b. The digital image signal output from the DSP 507 may be transmitted as a video signal through a video filter 509 and a video output unit 31c. Hence, the DSP 507 may include a micro controller.

An audio processor 513 outputs a voice signal input through a microphone MIC through the DSP 507 or a speaker SP. The audio processor 513 also outputs an audio signal input from the DSP 507 through the speaker SP.

As described above, in a digital image processing apparatus having a rotating display device according to the present invention, the rotating display device may include a direction sensor to easily sense a rotation of the rotating display device.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A digital image processing apparatus comprising:
a body;
a display panel rotatably coupled with the body, the display panel displaying an image on a first surface;
a substrate coupled to a second surface of the display panel opposite the first surface;
first and second conductive contacts configured on the substrate in a spaced apart relationship;
a movable conductive member configured to electrically connect with the first and second conductive contacts according to an orientation of the rotating display device; and
a sensor that detects the movable conductive member is bridging the first and second conductive contacts.

2. The digital image processing apparatus of claim 1, wherein the movable conductive member comprises a bar configured to extend between the first and second conductive contacts, the bar being movable between a first position in which the bar is electrically isolated from at least one of the first and second conductive contacts, and a second position in which the bar is bridging the first and second conductive contacts.

3. The digital image processing apparatus of claim 2 further comprising a cover connected to the substrate, the cover being configured to enclose the bar and the first and second conductive contacts.

4. The digital image processing apparatus of claim 3, wherein the cover includes a portion that is configured to urge the bar into positive contact with the first and second conductive contacts.

5. The digital image processing apparatus of claim 1, wherein the sensor is a current sensor that detects a current through the movable conductive member.

6. The digital image processing apparatus of claim 5, wherein the display panel adjusts an orientation of the image according to the current.

7. The digital image processing apparatus of claim 5 further comprising a controller in communication with the current sensor and the display panel, the controller determining the orientation of the image based on an output from the current sensor.

8. The digital image processing apparatus of claim 1 further comprising a power supply unit that applies a voltage across the first and second conductive contacts,
wherein the movable conductive member defines a switch configured to close a normally open contact defined between the first and second conductive contacts.

9. The digital image processing apparatus of claim 1, wherein the body comprises:
a case;
a PCB mounted inside the case; and
a direction sensor positioned on a surface of the PCB to sense an orientation of the body,
wherein the direction sensor comprises:
at least one conductive contact point disposed on the PCB;
a cover enclosing the at least one conductive contact point with the PCB; and
a direction-indicating unit capable of electrically connecting the at least one conductive contact point to a contact selected from the group consisting of the cover and another of the at least one conductive contact point disposed on the PCB.

10. The digital image processing apparatus of claim 1, wherein one of the first and second conductive contacts is a conductive trace on the substrate and the other one of the first and second conductive contacts is a conductive cover connected to the substrate, the conductive cover being configured to enclose the movable conductive member and the conductive trace.

11. The digital image processing apparatus of claim 10, wherein the movable conductive member comprises at least one ball, the at least one ball being configured to bridge a gap between the conductive cover and the conductive trace.

12. The digital image processing apparatus of claim 11, wherein each ball has a diameter that is smaller than the gap, the current passing through at least two balls.

13. The digital image processing apparatus of claim 11, wherein the conductive cover includes a portion that is configured to urge the at least one ball into positive contact with the conductive trance and the conductive cover.

14. The digital image processing apparatus of claim 1 further comprising third and fourth conductive contacts configured on the substrate in a spaced apart relationship,
wherein the movable conductive member is configured to electrically connect with two of the first, second, third and fourth conductive contacts according to an orientation of the rotating display device.

15. The digital image processing apparatus of claim 1 further comprising:
third and fourth conductive contacts configured on the substrate in a spaced apart relationship; and
a conductive cover connected to the substrate, the conductive cover being configured to enclose the movable conductive member and the first, second, third and fourth conductive traces,
wherein the movable conductive member is configured to electrically connect the conductive cover with one of the first, second, third and fourth conductive contacts according to an orientation of the rotating display device.

16. The digital image processing apparatus of claim 14 wherein the conductive cover has a polygonal shape with four vertices, each one of the first, second, third and fourth conductive contacts being configured proximate to one of the four vertices.

17. A rotating display device for a digital image processing apparatus, the rotating display device comprising:
a display panel rotatably coupled with a body portion of the digital image processing apparatus, the display panel displaying an image on a first surface;
a substrate coupled to a second surface of the display panel;
first and second conductive contacts configured on the substrate in a spaced apart relationship;
a movable conductive member configured to electrically connect with the first and second conductive contacts according to an orientation of the rotating display device; and
a sensor that detects the movable conductive member is bridging the first and the second conductive contacts.

18. The rotating display device of claim 17, wherein the movable conductive member comprises a bar configured to extend between the first and second conductive contacts, the bar being movable between a first position in which the bar is electrically isolated from at least one of the first and second conductive contacts, and a second position in which the bar is bridging the first and second conductive contacts.

19. The rotating display device of claim 17, wherein one of the first and second conductive contacts is a conductive trace on the substrate and the other one of the first and second conductive contacts is a conductive cover connected to the substrate, the conductive cover being configured to enclose the movable conductive member and the conductive trace.

20. The rotating display device of claim 19, wherein the movable conductive member comprises at least one ball, the at least one ball being configured to bridge a gap between the conductive cover and the conductive trace.

21. The rotating display device of claim 17 further comprising third and fourth conductive contacts configured on the substrate in a spaced apart relationship,
wherein the movable conductive member is configured to electrically connect with two of the first, second, third and fourth conductive contacts according to the orientation of the rotating display device relative to an orientation of the body portion of the digital image processing apparatus.

22. The digital image processing apparatus of claim 17, wherein the sensor is a current sensor that detects a current through the movable conductive member.

23. The digital image processing apparatus of claim 22, wherein the display panel adjusts an orientation of the image according to the current.
